(19) United States
(12) Patent Application Publication
(10) Pub. No.: US 2002/0068478 A1
(43) Pub. Date: Jun. 6, 2002

(54) Card connector board attachment structure

(76) Inventor: Yoshinori Watanabe, Kawasaki (JP)

Correspondence Address: Tyco Technology Resources, Suite 450, 4550 New Linden Hill Road, Wilmington, DE, 19808, US

(21) Appl. No.: 10/007,591

(22) Filed: Dec. 5, 2001

(30) Foreign Application Priority Data
Dec. 5, 2000 (JP) 2000-370048

(51) Int. Cl. H02B 1/01

(52) U.S. Cl. 439/573

(57) ABSTRACT

The card connector of the present invention has a housing, contacts and inserts. The attachment portions of the housing are placed on the board, and bolts are passed through the attachment portions from the side of the board and threadedly engaged with the inserts. There is no gap between the inserts and the housing, and likewise no gap between the bolts and inserts. Accordingly, even if an external force is applied to the housing in the lateral direction, the board and housing show no shift in position. Since the ends of the inserts are positioned near the board, a shearing force acts rather than a force that bends the shafts of the bolts, so that the resistance to external forces is extremely large, and deformation tends not to occur.

### FIELD OF THE INVENTION

The present invention relates to an electrical connector board attachment structure.

### BACKGROUND OF THE INVENTION

In the past, electrical connectors and in particular card receiving electrical connectors that are attached to boards have been used in equipment such as laptop personal computers. The card connector assembly disclosed in Japanese Unexamined Patent Publication No. 8(1996)-96903 is a known electrical connector of this type. Card connector assemblies of this type are usually disposed on both sides of a single board, and are fastened to the board by bolts and inserts with spacers positioned therebetween. The attachment apertures in the housing are generally formed as oversize holes having an external diameter which is larger than the corresponding bolts. Accordingly, the bolts are positioned in the attachment apertures such that there is a slight gap between the bolts and the inside surfaces of the attachment apertures. Numerous contacts which are connected to an inserted card are disposed in the housing, and these contacts are usually soldered to the board at tine portions that protrude outward from the housing.

In cases where connectors of the type disclosed in the above-mentioned Japanese Unexamined Patent Publication No. 8(1996)-96903 are used, the card may protrude to the outside of the equipment in a normal operating state, depending on the type of equipment involved. In cases where an external force (impact force) is applied to the card as a result of such equipment bumping against other objects or accidentally being dropped, this force is transmitted to the connector through the card. Especially in cases where the equipment is dropped so that an external force is applied directly to the card, this external force is applied to the connector via the card as a direct impact force. In such a case, since there is a slight gap, as was described above, between the housing and the bolts fastening the connector, the housing may shift so that cracks are generated in the solder connection portions of the tines. These cracks usually result in a loss of electrical contact between the tines and circuits on the board. Furthermore, as a result of gaps being present between the bolts and the inside surfaces of the attachment holes, the bolts flex or bend as a result of the external impact force, further contributing to shifting of the housing.

### SUMMARY OF THE INVENTION

An object of the present invention is to provide a card connector board attachment structure with highly reliable electrical connections, in which there is reduced damage to the solder connection portions of when the card connector attached to the board is subjected to a large external force.

The card connector board attachment structure of the present invention has an insulating housing which accommodates a card. Contacts in the housing are connected to the card tines of the contacts are soldered to the board and the housing has attachment portions that are threadedly fastened to the board. Wherein through-holes are formed in the attachment portions for receiving inserts. Bolts which pass through the board and are screwed into the inserts are attached from an opposite side of the board; each insert has an integral body portion which has a threaded aperture that is concentric with the through-hole and that threadedly engages with the corresponding bolt and a head portion which pushes the housing toward the board as a result of the threaded engagement with the bolt. The body portions are press-fitted in the through-holes and the ends of the press-fitted body portions are positioned in the vicinity of the board.

Accordingly, the likelihood that the solder connection portions of the tines be cracked or damaged is minimized, and the reliability of the electrical connections of the connector is therefore improved.

### BRIEF DESCRIPTION OF THE DRAWINGS

The invention will now be described by way of example with reference to the accompanying figures of which:

FIG. 1 is a front view which shows the card connector of the present invention together with a board.

FIG. 2 is a plan view of the card connector of FIG. 1.

FIG. 3 is a side view of the card connector of FIG. 1.

FIG. 4 is a rear view of the card connector of FIG. 1.

FIG. 5 is a bottom view of the card connector of FIG. 1.

FIG. 6 is a cross section along line 6-6 of the card connector of FIG. 2.

FIG. 7 shows a insert that is mounted on an attachment portion; FIG. 7A is a front view of the insert, FIG. 7B is a plan view, and FIG. 7C is a bottom view.

FIG. 8 is a partial enlarged cross section of the portion of the attachment structure of each attachment portion that is surrounded by the broken line A in FIG. 6. This figure shows a state in which this attachment portion is mounted on the board by a bolt.

FIG. 9 is a bottom view of a card connector assembly using the card connector of the present invention.

FIG. 10 is a front view of the card connector assembly shown in FIG. 9.

FIG. 11 shows side views of the card connector assembly shown in FIG. 9;

FIG. 11A is a left-side view, and

FIG. 11B is a right-side view.

### DESCRIPTION OF THE PREFERRED EMBODIMENTS

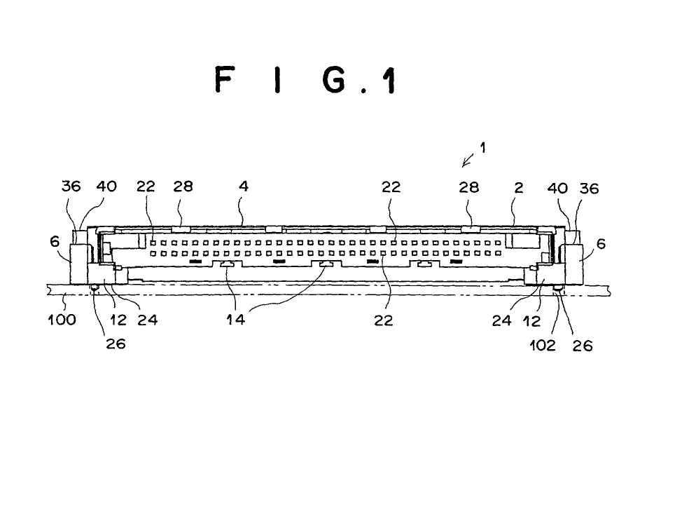

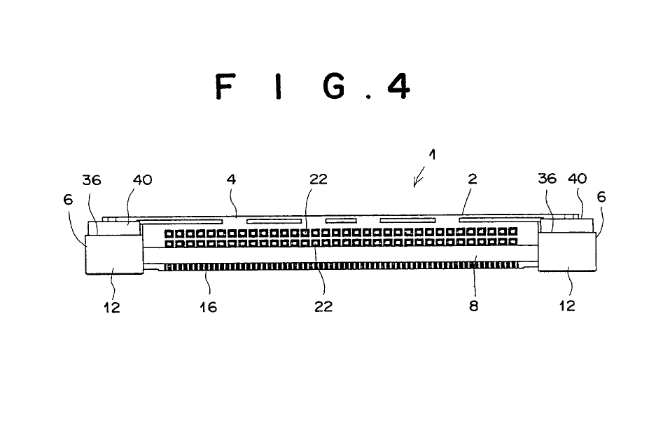

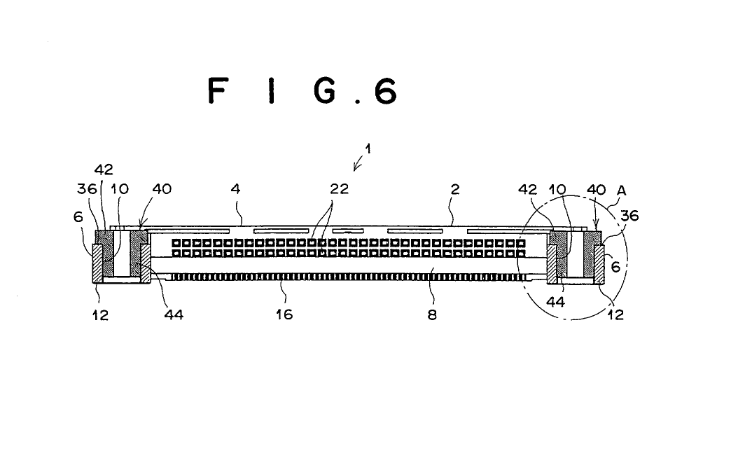

A preferred embodiment of the card connector board attachment structure of the present invention will now be described in detail Referring to FIGS. 1 through 6, the housing 2 has an oblong, substantially rectangular shape. In the housing 2, an upper wall 4, side walls 6 which are positioned on both sides of this upper wall 4, and a rear wall 8 which connects both side walls 6, 6, are molded as an integral unit from a synthetic resin. On the rear portions of both ends of the housing 2, rectangular attachment portions 12 in which through-holes 10 are formed are molded as integral parts of the side walls 6 and rear wall 8 such that these attachment portions 12 protrude outward from both the side walls 6 and rear wall 8. A taper 46 is formed on the end portion of the front side of each attachment portion 12. The lower side of the housing 2, i.e., the side nearest the board 100, does not have a part corresponding to the upper wall 4. The area forward of the rear wall 8 is an open space that is used to accommodate the card.

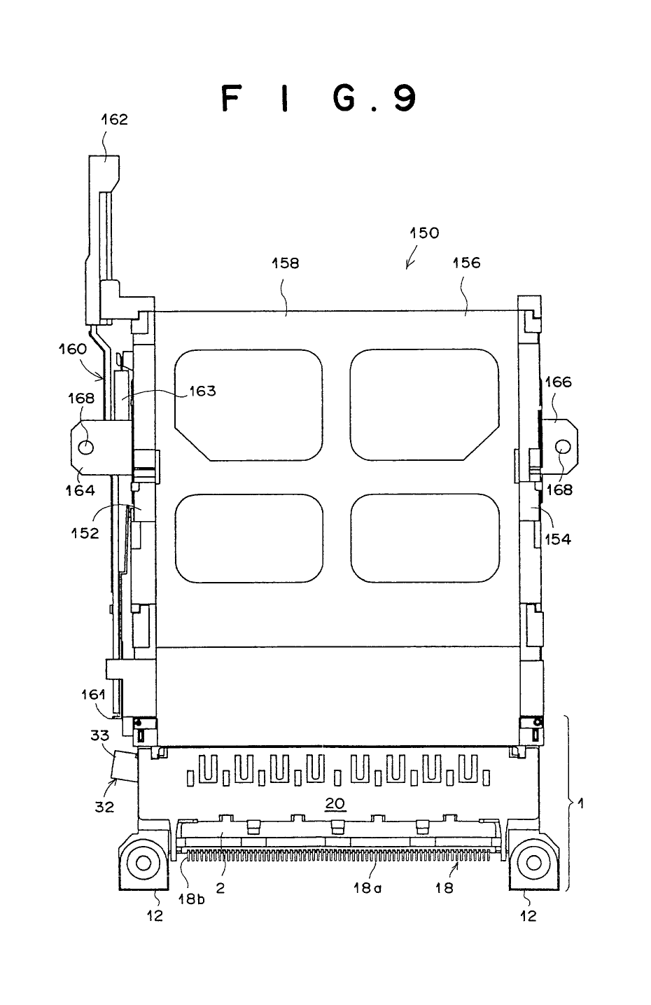

Three T-shaped projections 14 used for the attachment of a ground plate 20 (FIG. 9) are protrude on the undersurface of the rear wall 8 at predetermined intervals along the 30 length of the housing 2 (FIG. 1). Numerous contact holding grooves 16 are formed in the lower portion of the rear end of the rear wall 8 of the housing 2 along the length of the rear wall 8. Several contact holding apertures 22 which frictionally receive the contacts 18 (FIG. 9) pass through the rear wall 8. After protruding to the outside of the rear portion of the housing 2 from the contact holding apertures 22, the contacts 18 are bent toward the side of the board 100 to form tines 18a (FIG. 9). Furthermore, the connection portions 18b of the tines 18a (FIG. 9) are formed substantially parallel to the board 100 for soldering thereto.

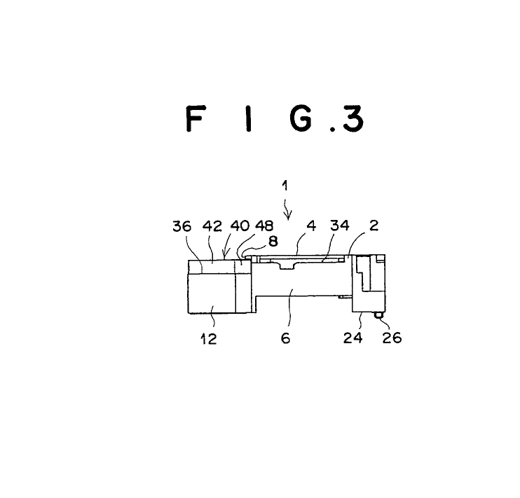

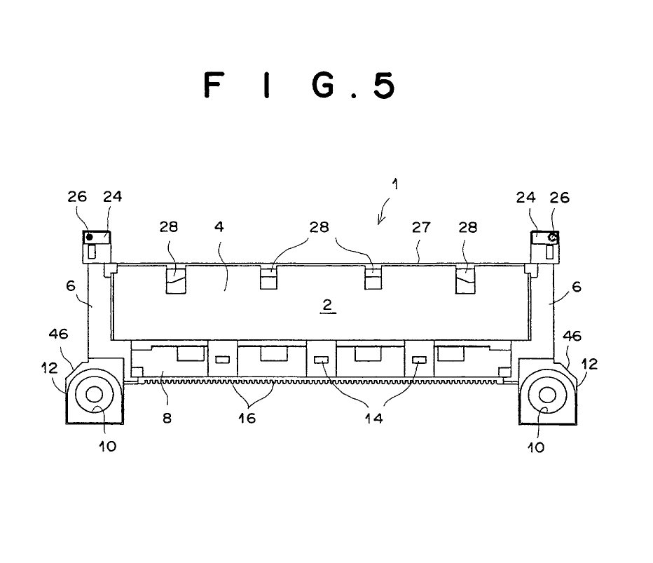

Substantially cylindrical bosses 26 which advance into apertures 102 in the board 100 are formed on the bottom surfaces 24 of the respective side walls 6 near the ends of the side walls 6 (FIGS. 1, 3 and 5). These bosses 26 are used to position the connector 1 when the connector 1 is attached to the apertures 102 of the board 100. Four flat projections 28 protrude at substantially equal intervals from the inside surface of the upper wall 4 near the front end 27 of the upper wall 4 (FIG. 5). These projections 28 are used to regulate movement of a cam bar 32 (FIG. 9) disposed on the upper wall 4. As best shown in FIG. 3, a slot 34 which extend along the housing 2 is formed in the side wall 6 in the vicinity of the upper wall 4. The cam bar 32 protrudes from this slot 34, and is connected to an operating rod 160 (FIG. 9) which will be described later.

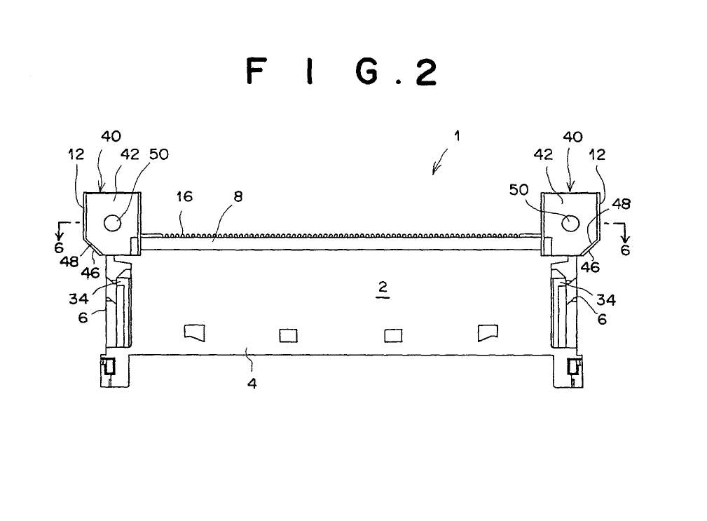

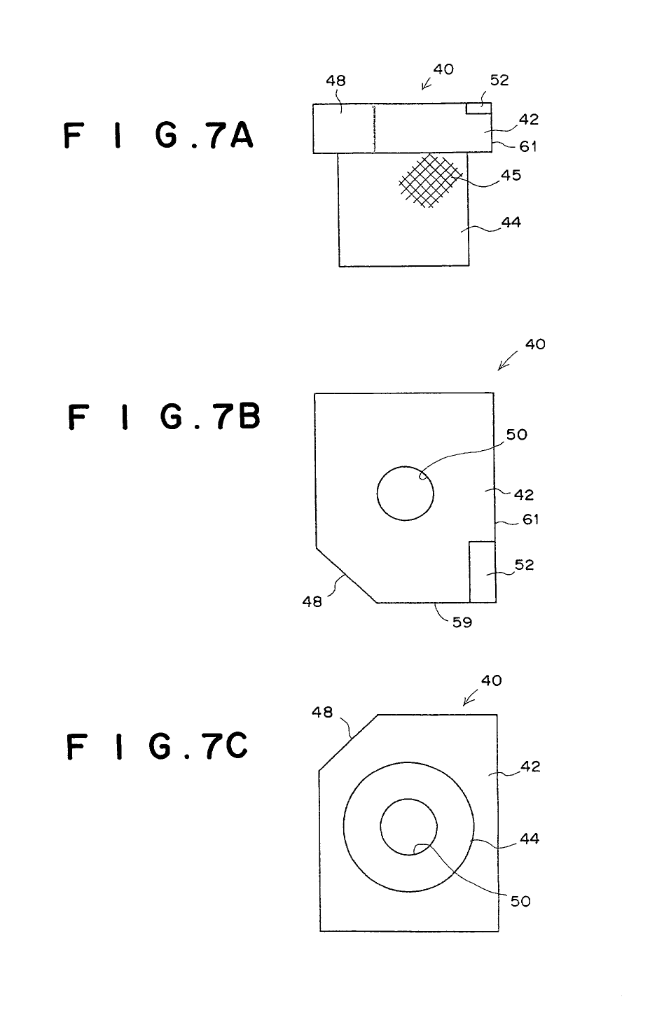

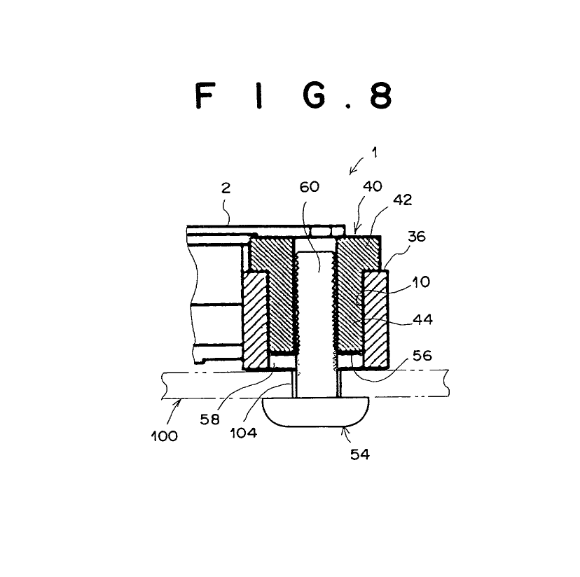

Next, the attachment portions 12 will be described in detail with reference to both FIG. 7 and FIG. 8. FIG. 7 shows an insert that is mounted on each of these attachment portions 12. A through-hole 10 is formed in each attachment portion 12 so that this through-hole 10 runs perpendicular to the board 100 from the upper surface 36 of the attachment portion 12. The shape of the insert 40 that is attached to this through-hole 10 will be described with reference to FIG. 7. This insert 40 is preferably made of metal, and has a substantially square head portion 42 and a cylindrical body portion 44 which is formed as an integral unit with this head portion 42 beneath the head portion 42. A threaded aperture 50 is formed in the center of the body portion 44 and extends concentrically with the through-hole 10. Furthermore, diagonally cross-hatched knurling 45 is applied over the entire circumferential surface of the body portion 44. FIG. 7A shows only a portion of the shape of this knurling 45. Furthermore, the knurling may also be a parallel knurling in which the grooves extend in the vertical direction. The head portion 42 has a taper 48 formed by cutting away one comer. This taper 48 is complementary to the similar taper 46 (FIGS. 2 and 5) formed on the corresponding attachment portion 12.

Furthermore, as shown in FIG. 7A and 7B, a rectangular recess 52 is formed in each head portion 42 on the opposite side from the taper 48. The recess 52 is formed so that it opens at the end edge 59 and side edge 61. This recess 52 is formed as a relief in order to avoid interference with the other end of the cam bar 32. Since the diameter of the body portion 44 of each insert 40 is formed so that this diameter is slightly larger than the internal diameter of the through-hole 10 in the corresponding attachment portion 12, mounting in the through-holes 10 is accomplished by press-fitting the body portions 44 of the inserts 40 in the through-holes 10 from the upper surfaces 36 of the attachment portions 12. As a result, the housing 2 and inserts 40 form an integral unit, so that there is no relative movement between the respective parts. In this case, as a result of the knurling 45, the inserts 40 are attached so that the inserts 40 bite into the housing 2; accordingly, the inserts 40 are firmly fastened. In the case of the parallel knurling, insertion resistance of the body portions 44 is reduced, so that the press-fitting work is facilitated.

In order to fasten these attachment portions 12 to the board 100, the attachment portions 12 are placed on the board 100 as shown in FIG. 8. Next, from the side of the board 100, bolts 54 are passed through apertures 104 in the board 100, and are threadedly engaged with the inserts 40. As a result, the upper surfaces 36 of the attachment portions 12 are urged toward the board 100 by the head portions 42 of the inserts 40, so that the housing 2 is fastened to the board 100. There is no gap between the inserts 40 and the attachment portions 12 of the housing 2, and likewise no gap between the bolts 54 and the inserts 40. Accordingly, even if an external force is applied in the lateral direction to the housing 2 fastened to the board 100, the board 100 and housing 2 will not shift.

Furthermore, it is important that the ends 56 of the body portions 44 be positioned in the vicinity of the surface of the board 100 when the inserts 40 are press-fitted in the through-holes 10. Since the height of the gaps 58 formed between the ends 56 of the inserts 40 and the board 100 is low compared to the length of the inserts 40, bending of the shafts 60 of the bolts 54 inside these gaps 58 tends not to occur. In other words, a force which is closer to the shearing direction than to the direction that causes bending of the shafts 60 acts on the bolts 54, so that the bolts 54 have an extremely large resistance to external forces. Accordingly, no stress is applied to the solder connection portions 18b of the tines 18a (FIG. 9) that protrude from the rear of the housing 2. Furthermore, since the head portions 42 of the inserts 40 urge the attachment portions 12 of the housing 2 toward the board 100, the housing 2 is prevented from lifting off of the board 100.

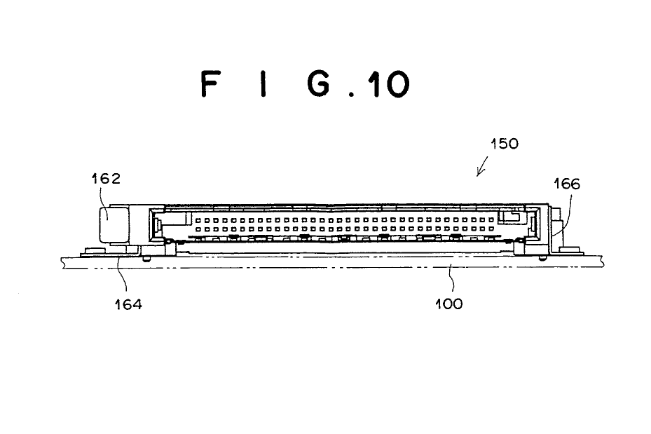

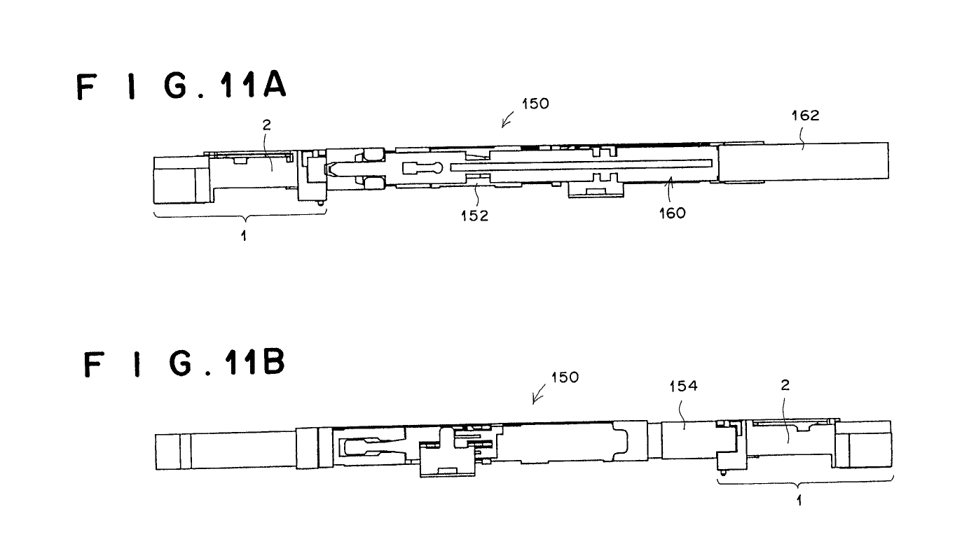

Next, a connector assembly 150 using the connector 1, will be described with reference to FIGS. 9 through 11. As shown in FIG. 9, guides 152 and 154 preferably made of a synthetic resin which are used to guide the card are attached to both sides of the front part of the housing 2. A metal shell 156 is attached between these guides 152 and 154 on the side away from the board 100. The shell 156 is formed with a substantially rectangular shape, and is constructed so that the card is accommodated between the shell 156 and the board 100 via an opening in the front part 158 of the shell 156.

Substantially L-shaped attachment tabs 164 and 166 which are used to attach the assembly 150 to the board 100 are attached to the guides 152 and 154. The attachment tabs 164 and 166 are attached by an interlocking engagement with grooves (not shown in the figures) formed in the guides 152 and 154. Apertures 168 are formed by burring in these attachment tabs 164 and 166. When the assembly 150 is attached to the board 100, bolts (not shown in the figures) are passed through these apertures 168 from the side of the board 100, and are threadedly engaged with the apertures 168.

An operating rod 160 which has a knob 162 on its end is attached to the guide 152 so that this operating rod 160 can slide. The operating rod 160 is ordinarily driven by a spring 163 causing it to move away from the connector 1. When the card is to be ejected, this is accomplished by pressing the knob 162 of the operating rod 160. When this knob is pressed, the end 161 of the operating rod 160 contacts the end part 33 of the cam bar 32 inside the housing 2 so that the cam bar 32 pivots. As a result, the other end (not shown in the figures) of the cam bar 32 pushes the end of the card so that the card is ejected from the connector 1. A ground plate 20 which accomplishes a ground connection of the inserted card is attached to the bottom surface of the housing 2; however, since this is a known structure, a detailed description is omitted.

What is claimed is:

1. A card connector board attachment structure comprising:
an insulating card receiving housing with attachment portions that are fastenable to a board,
the attachment portions having through-holes that are perpendicular to the surface of the board,
inserts mounted on the attachment portions; and,
contacts having tines being solderable to the board, being secured in the housing and being connectable to an inserted card.

2. The card connector board attachment structure of claim 1 wherein the inserts further comprise a threaded through-hole extending therethrough.

3. The card connector board attachment structure of claim 2 wherein the inserts further comprise knurling along an outer peripheral surface thereof.

4. The card connector board attachment structure of claim 3 further comprising bolts which pass through the board and are threadedly engaged into the inserts to secure the housing to the board.

5. The card connector board attachment structure of claim 4 wherein the inserts further comprise a head portion which urges the housing toward the board as a result of the threaded engagement with the bolt.

6. The card connector board attachment structure of claim 5 wherein the inserts are press-fitted in the through-holes of the attachment portions, and the ends of the press-fitted body portions are positioned in the vicinity of the board.
